(19) United States
(12) Patent Application Publication
(10) Pub. No.: US 2020/0353581 A1
(43) Pub. Date: Nov. 12, 2020

(54) INDUSTRIAL MACHINE

(71) Applicant: FANUC CORPORATION, Yamanashi (JP)

(72) Inventor: Noriaki HATANAKA, Yamanashi (JP)

(73) Assignee: FANUC CORPORATION, Yamanashi (JP)

(21) Appl. No.: 16/851,364

(22) Filed: Apr. 17, 2020

(30) Foreign Application Priority Data
May 8, 2019 (JP) 2019-088244

(51) Int. Cl. B23Q 5/54

(52) U.S. Cl. CPC B23Q 5/54

(57) ABSTRACT

An industrial machine is an industrial machine which has a history recording function, and includes: a manual pulse generator which includes a handle for manually operating the position of a drive axis in the industrial machine by an operator; a drive axis control unit which controls the drive axis according to the operation of the handle; a handle operation determination unit which determines the operation of the handle; and an operation history recording unit which records, as an operation history, the operation of the handle determined with the handle operation determination unit, and when the number of rotations of the handle exceeds a threshold value, the handle operation determination unit determines the operation of the handle, and the operation history recording unit records, as the operation history, the operation of the handle.

This application is based on and claims the benefit of priority from Japanese Patent Application No. 2019-088244, filed on 8 May 2019, the content of which is incorporated herein by reference.

### BACKGROUND OF THE INVENTION

### Field of the Invention

The present invention relates to an industrial machine which has a history recording function.

### Related Art

For example, a machine tool has a history recording function of recording the histories of an operation and the like. Examples of such a history include:
the operation history of an MDI (Manual Data Input) key which is performed by an operator;
the history of an external operator message;
the history of an alarm which is generated;
the change history of various types of data such as a parameter, a tool offset, a work piece offset (work piece shift amount) and a custom macro common variable;
the history of input/output signals; and
   the like.

The history recording function as described above is useful for:
the investigation of a cause when there is a concern in the operation of the machine tool;
the estimation of a cause when a failure occurs in the machine tool; and
   the like. For example, with the history recording function as described above, it is possible to determine an operation error caused by an operator and to determine a change in the position of a drive axis in the machine tool (in this way, for example, a failure in a detector or a drive part is estimated).

Incidentally, for example, in order to adjust the position of a drive axis, a machine tool may include a manual pulse generator which includes a handle for manual operation by an operator. However, in the history recording function of a conventional machine tool, the history of a handle operation (that is, the operation of a manual pulse generator) by an operator is not recorded. Hence, it is difficult to determine the cause of an event where a handle operation (that is, the operation of a manual pulse generator) by an operator is a factor.

In the history recording function of the conventional machine tool, the turning on and off of a dedicated mode can be recorded as the history of a signal, and thus the turning on and off of a handle mode for a manual operation by the operator can be recorded as the history of a signal. However, even when the handle mode is turned on, in actuality, the operator does not always perform the handle operation. In this regard, it can be considered that in the history recording function of the conventional machine tool, the signal of the handle mode and the signal of an axis movement are combined and are recorded. However, it takes time to analyze the combination of these signals. In the case of a handle interrupt in an automatic operation, it is difficult to distinguish whether an axis movement is caused by the automatic operation or by a handle operation.

In this regard, Patent Document 1 discloses a technology in which as the history of a handle operation (that is, the operation of a manual pulse generator) by an operator, a pulse handle superimposition mode and a pulse handle superimposition amount are recorded.

Patent Document 1: PCT International Publication No. WO00/10769

### SUMMARY OF THE INVENTION

Incidentally, an event (for example, a failure in a machine tool) where a handle operation (that is, the operation of a manual pulse generator) by an operator is a factor (for example, an operation error caused by the operator) often occurs when the amount of manual operation by the operator is relatively large. Hence, in order to determine the cause of an event where a handle operation (that is, the operation of a manual pulse generator) by an operator is a factor, it is not necessary to record a detailed history like a pulse handle superimposition amount as in the technology disclosed in Patent Document 1.

As described above, in the field of industrial machines such as a machine tool, it is desired to easily record the history of a handle operation (that is, the operation of a manual pulse generator) by an operator.

An industrial machine of the present disclosure is an industrial machine which has a history recording function, and includes: a manual pulse generator which includes a handle for manually operating the position of a drive axis in the industrial machine by an operator; a drive axis control unit which controls the drive axis according to the operation of the handle; a handle operation determination unit which determines the operation of the handle; and an operation history recording unit which records, as an operation history, the operation of the handle determined with the handle operation determination unit, and when the number of rotations of the handle exceeds a threshold value, the handle operation determination unit determines the operation of the handle, and the operation history recording unit records, as the operation history, the operation of the handle.

According to the present disclosure, in the field of industrial machines such as a machine tool, it is possible to easily record the history of a handle operation (that is, the operation of a manual pulse generator) by an operator.

### BRIEF DESCRIPTION OF THE DRAWINGS

FIG. 1 is a diagram showing a main configuration on the history recording function of a machine tool according to the present embodiment, that is, the configuration of a numerical controller in the machine tool;

FIG. 2 is a diagram for illustrating an example of a handle operation determination using a handle operation determination unit in the numerical controller of the machine tool shown in FIG. 1;

FIG. 3 is a diagram for illustrating another example of the handle operation determination using the handle operation determination unit in the numerical controller of the machine tool shown in FIG. 1;

FIG. 4 is a diagram for illustrating yet another example of the handle operation determination using the handle operation determination unit in the numerical controller of the machine tool shown in FIG. 1; and

FIG. 5 is a diagram for illustrating still another example of the handle operation determination using the handle operation determination unit in the numerical controller of the machine tool shown in FIG. 1.

### DETAILED DESCRIPTION OF THE INVENTION

An example of an embodiment of the present invention will be described below with reference to accompanying drawings. In the drawings, the same or corresponding portions are identified with the same reference numerals.

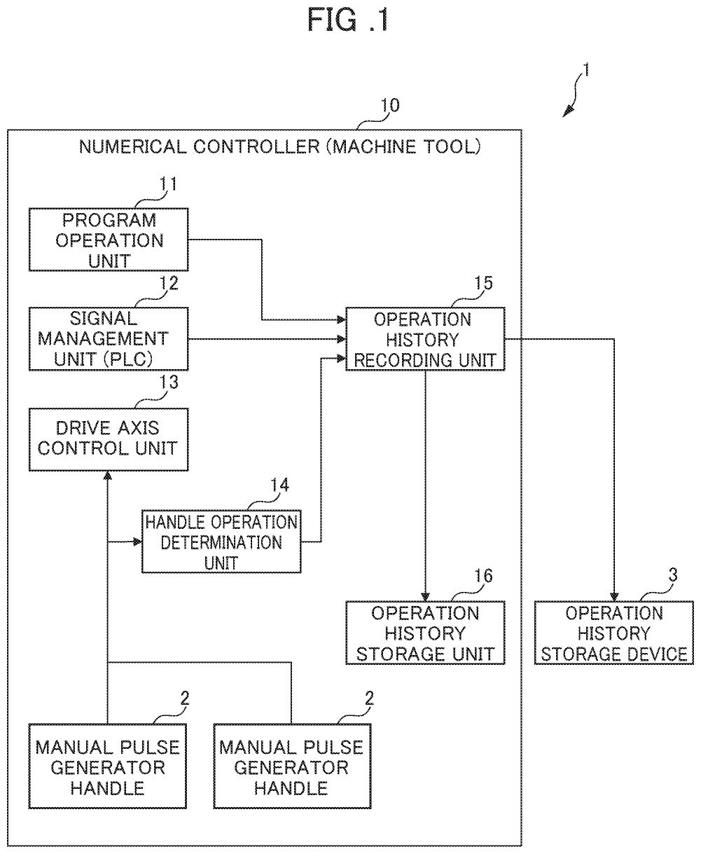

FIG. 1 is a diagram showing a main configuration on the history recording function of a machine tool according to the present embodiment, that is, the configuration of a numerical controller in the machine tool. The numerical controller 10 of the machine tool 1 shown in FIG. 1 has the history recording function of the machine tool, and includes a plurality of manual pulse generators 2 which include handles, a program operation unit 11, a signal management unit (PLC) 12, a drive axis control unit 13, a handle operation determination unit 14, an operation history recording unit 15 and an operation history storage unit 16.

The program operation unit 11, the signal management unit (PLC) 12, the drive axis control unit 13 and the handle operation determination unit 14 in the numerical controller 10 are formed with, for example, a computation processor such as a CPU (Central Processing Unit) or an FPGA (Field-Programmable Gate Array). Various types of functions of the program operation unit 11, the signal management unit (PLC) 12, the drive axis control unit 13 and the handle operation determination unit 14 in the numerical controller 10 are realized, for example, by executing predetermined software (programs and applications) stored in the storage unit. Various types of functions of the program operation unit 11, the signal management unit (PLC) 12, the drive axis control unit 13 and the handle operation determination unit 14 in the numerical controller 10 may be realized by the cooperation of hardware and software or may be realized by only hardware (electronic circuit).

The operation history recording unit 15 and the operation history storage unit 16 are, for example, rewritable memories such as an EEPROM or for example, rewritable disks such as a HDD (Hard Disk Drive) or an SSD (Solid State Drive).

The manual pulse generator 2 includes the handle for adjusting the positions of drive axes (for example, an X axis, a Y axis and a Z axis) in the machine tool and for a manual operation by an operator. The manual pulse generator 2 outputs a signal of a pulse train corresponding to the number of rotations of the rotary handle. One manual pulse generator 2 (and the handle) may be provided for a plurality of drive axes in the machine tool or a plurality of manual pulse generators 2 (and handles) may be respectively provided for a plurality of drive axes.

The program operation unit 11 controls the operation of the machine tool based on, for example, a machining program.

The signal management unit 12 is, for example, a PLC (Programmable Logic Controller), and controls the sequence of input/output signals for the machine tool.

The drive axis control unit 13 controls the positions of the drive axes in the machine tool according to a handle operation by the operator.

The handle operation determination unit 14 determines the handle operation. The details of the handle operation determination unit 14 will be described later.

The operation history recording unit 15 records the operation histories of:
the operation of an MDI (Manual Data Input) key which is performed by the operator;
an external operator message;
an alarm which is generated;
the change of various types of data such as a parameter, a tool offset, a work piece offset (work piece shift amount) and a custom macro common variable; and
   the like which are acquired from the program operation unit 11.

The operation history recording unit 15 records, as operation histories,
the input/output signals; and
   the like which are acquired from the signal management unit (PLC) 12.

The operation history recording unit 15 records, as an operation history, the handle operation determined with the handle operation determination unit 14.

The operation history storage unit 16 stores the operation histories recorded in the operation history recording unit 15.

The operation histories may be recorded, instead of the operation history storage unit 16 within the machine tool, in an operation history storage device 3 outside the machine tool.

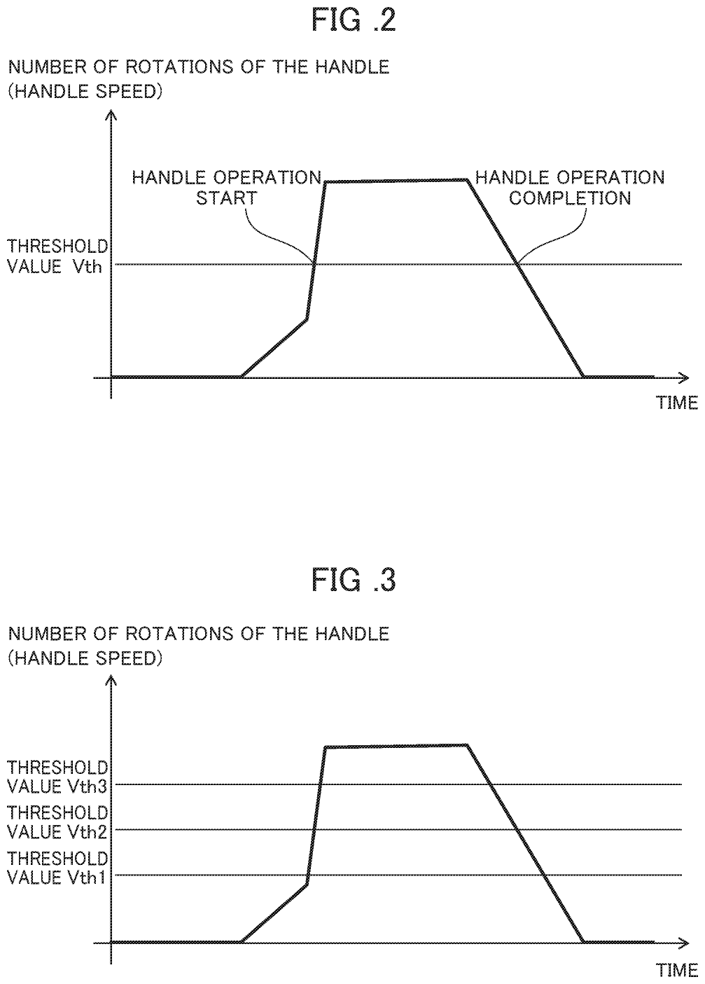

The handle operation determination unit 14 and the operation history recording unit 15 will be described below with reference to FIG. 2. FIG. 2 is a diagram for illustrating an example of a handle operation determination using the handle operation determination unit in the numerical controller of the machine tool shown in FIG. 1.

As shown in FIG. 2, when the number of rotations of the handle (handle speed) exceeds a threshold value Vth, the handle operation determination unit 14 determines the handle operation. Specifically, when the number of rotations of the handle (handle speed) exceeds the threshold value Vth, the handle operation determination unit 14 determines the start of the handle operation. When the number of rotations of the handle (handle speed) drops below the threshold value Vth, the handle operation determination unit 14 determines the completion of the handle operation.

The threshold value Vth is set to the number of rotations of the handle, that is greater than 1, at which an event (for example, a failure in the machine tool) where the handle operation is a factor (for example, an operation error caused by the operator) is estimated to occur. The threshold value Vth may be previously determined so as to be set, may be input with an input means such as the MDI key in the machine tool so as to be recorded or may be set through a communication means from a PC or the like which is connected to the machine tool.

When a plurality of manual pulse generators 2 (and a plurality of handles) are respectively provided for a plurality of drive axes in the machine tool, the handle operation determination unit 14 may have a different threshold value for each of the handles in the manual pulse generators.

When the number of rotations of the handle (handle speed) exceeds the threshold value Vth, and the handle operation determination unit 14 determines the handle operation, the operation history recording unit 15 records the handle operation as the operation history. Specifically, when the number of rotations of the handle (handle speed) exceeds the threshold value Vth, and the handle operation determination unit 14 determines the start of the handle operation, the operation history recording unit 15 records the start of the handle operation as the operation history. When the number of rotations of the handle (handle speed) drops below the threshold value Vth, and the handle operation determination unit 14 determines the completion of the handle operation, the operation history recording unit 15 records the completion of the handle operation as the operation history.

Here, in manual handle operations, the operator rotates, in a handle mode, the handle in the manual pulse generator 2 on a machine operation panel so as to be able to feed the drive axes according to the amount of rotation.

As the manual handle operations, the following operations are present.
Manual handle feed
Further manual handle feed in a jog feed mode with a parameter, that is, in a state where the drive axis is fed
Manual handle interrupt: further manual handle feed in an automatic operation mode with a machining program
   In other words, in the manual handle interrupt, the manual handle feed is performed so as to be superimposed on the movement of the automatic operation.
Manual linear feed: simultaneous linear feed with two axes parallel along a specified straight line having an angle on an XY plane, a YZ plane and a ZX plane by one manual handle operation
Arc interpolation feed: simultaneous arc feed with two axes along a specified circle on the XY plane, the YZ plane and the ZX plane by one manual handle operation
   Handle synchronous feed: manual handle feed at a feed speed synchronous with the rotation of the manual handle operation instead of a feed speed specified in the machining program of the automatic operation
   Manual handle retrace: in the automatic operation mode, the direction of execution of the program and the speed of execution thereof are controlled by the manual handle operation. For example, in the automatic operation mode, the handle of the manual pulse generator 2 is rotated in a positive direction, and thus the program is executed in a forward direction. Here, the speed of execution of the program is proportional to the number of rotations of the handle in the manual pulse generator 2. For example, when the handle of the manual pulse generator 2 is rapidly rotated in a positive direction, the speed is increased whereas when the handle of the manual pulse generator 2 is slowly rotated, the speed is lowered. On the other hand, in the automatic operation mode, the handle of the manual pulse generator 2 is rotated in a negative direction, and thus the program is executed in a backward direction. Here, the speed of execution of the program is proportional to the number of rotations of the handle in the manual pulse generator 2. For example, when the handle of the manual pulse generator 2 is rapidly rotated in a negative direction, the speed is increased whereas when the handle of the manual pulse generator 2 is slowly rotated, the speed is lowered.

As described previously, as the manual handle operations, a plurality of operations are present. On only one function of these manual handle operations, the handle operation determination and the operation history recording described above may be performed or for any of a plurality of functions which are effective, the handle operation determination and the operation history recording described above may be adopted.

Here, the event (for example, a failure in the machine tool) where the handle operation (that is, the operation of the manual pulse generator) by the operator is a factor (for example, an operation error caused by the operator) often occurs when the amount of manual operation by the operator is relatively large. Hence, in order to determine the cause of the event where the handle operation (that is, the operation of the manual pulse generator) by the operator is a factor, it is not necessary to record a detailed history like a pulse handle superimposition amount as in the technology disclosed in Patent Document 1.

In the numerical controller 10 of the present embodiment, that is, the machine tool 1, only when the number of rotations of the handle exceeds the threshold value, the handle operation is recorded as the operation history. In this way, for example, as compared with the technology disclosed in Patent Document 1, it is possible to reduce the complicated updating of the operation histories. Hence, a history confirmation is easily performed. It is possible to easily record, as the operation history, the handle operation in which the event (for example, a failure in the machine tool) occurs where the handle operation (that is, the operation of the manual pulse generator) by the operator is a factor (for example, an operation error caused by the operator).

In the numerical controller 10 of the present embodiment, that is, the machine tool 1, the event (for example, a failure in the machine tool) where the handle operation (that is, the operation of the manual pulse generator) by the operator is a factor (for example, an operation error caused by the operator) can be distinguished in:
the manual handle feed;
the further manual handle feed in the jog feed mode with the parameter, that is, in the state where the drive axis is fed;
the manual handle interrupt;
the manual linear feed;
the arc interpolation feed;
the handle synchronous feed; and
the manual handle retrace described above.
   For example, even in the manual handle interrupt in the automatic operation, it is possible to distinguish whether an axis movement is caused by the automatic operation or by the handle operation.

### (Variation 1)

FIG. 3 is a diagram for illustrating another example of the handle operation determination using the handle operation determination unit in the numerical controller of the machine tool shown in FIG. 1. As shown in FIG. 3, the handle operation determination unit 14 may have a plurality of threshold values Vth1, Vth2 and Vth3, and each time the number of rotations of the handle (handle speed) exceeds each of the threshold values Vth1, Vth2 and Vth3, the handle operation may be determined. Specifically, each time the number of rotations of the handle (handle speed) exceeds each of the threshold values Vth1, Vth2 and Vth3, the handle operation determination unit 14 may determine the start of the handle operation. Each time the number of rotations of the handle (handle speed) drops below each of the threshold values Vth1, Vth2 and Vth3, the handle operation determination unit 14 may determine the completion of the handle operation.

Each time the number of rotations of the handle (handle speed) exceeds each of the threshold values Vth1, Vth2 and Vth3, and the handle operation determination unit 14 determines the handle operation, the operation history recording unit 15 may record the handle operation as the operation history. Specifically, each time the number of rotations of the handle (handle speed) exceeds each of the threshold values Vth1, Vth2 and Vth3, and the handle operation determination unit 14 determines the start of the handle operation, the operation history recording unit 15 may record the start of the handle operation as the operation history. Each time the number of rotations of the handle (handle speed) drops below each of the threshold values Vth1, Vth2 and Vth3, and the handle operation determination unit 14 determines the completion of the handle operation, the operation history recording unit 15 may record the completion of the handle operation as the operation history.

In this way, even when the number of rotations of the handle is important in the investigation of the operation history, it is possible to easily record an approximate value of the handle speed.

### (Variation 2)

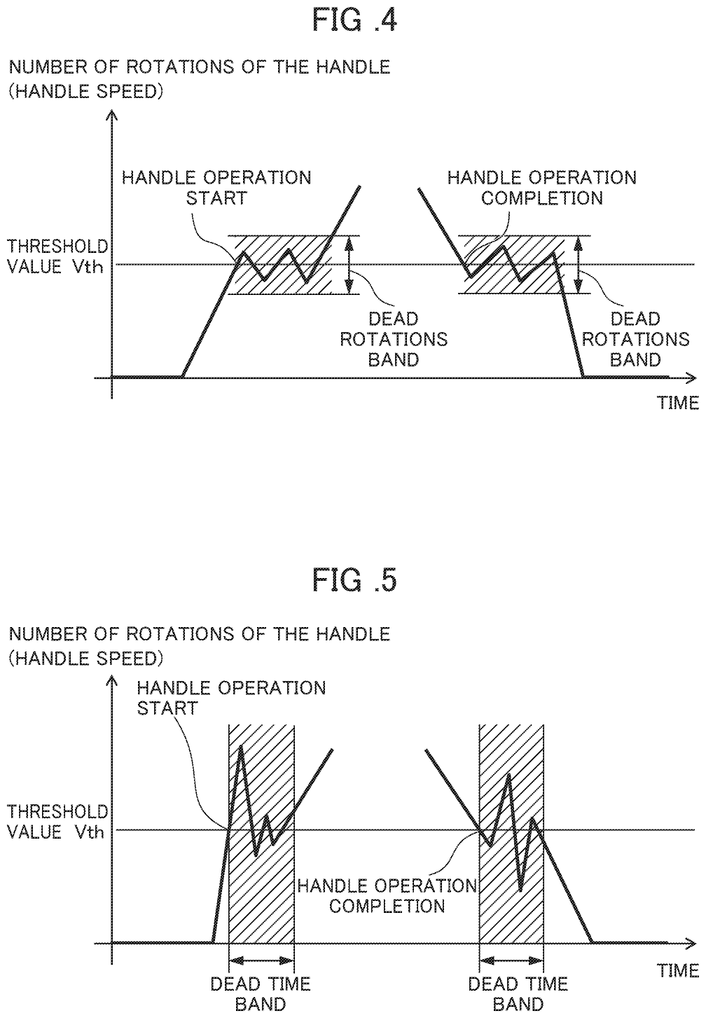

FIG. 4 is a diagram for illustrating yet another example of the handle operation determination using the handle operation determination unit in the numerical controller of the machine tool shown in FIG. 1. As shown in FIG. 4, the handle operation determination unit 14 may provide a dead rotations band which does not detect that the number of rotations of the handle exceeds the threshold value Vth or drops therebelow even when the number of rotations of the handle (handle speed) exceeds the threshold value Vth (even when the start of the handle operation is determined). The handle operation determination unit 14 may cancel the settings of the dead rotations band when the number of rotations of the handle (handle speed) exceeds the dead rotations band.

The handle operation determination unit 14 may provide a dead revolutions band which does not detect that the number of rotations of the handle exceeds the threshold value Vth or drops therebelow even when the number of rotations of the handle (handle speed) drops below the threshold value Vth (even when the completion of the handle operation is determined). The handle operation determination unit 14 may cancel the settings of the dead rotations band when the number of rotations of the handle (handle speed) drops below the dead rotations band.

In this way, even when chattering occurs in which the number of rotations of the handle (handle speed) is changed around the threshold value Vth for a short period of time, it is possible to reduce the unintended recording of a very large number of operation histories for a short period of time.

### (Variation 3)

FIG. 5 is a diagram for illustrating still another example of the handle operation determination using the handle operation determination unit in the numerical controller of the machine tool shown in FIG. 1. As shown in FIG. 5, the handle operation determination unit 14 may provide a dead time band which does not detect that the number of rotations of the handle exceeds the threshold value Vth or drops therebelow even when the number of rotations of the handle (handle speed) exceeds the threshold value Vth (even when the start of the handle operation is determined). For example, the handle operation determination unit 14 may set the dead time band for only a predetermined time which elapses after the number of rotations of the handle (handle speed) exceeds the threshold value Vth.

The handle operation determination unit 14 may provide a dead time band which does not detect that the number of rotations of the handle exceeds the threshold value Vth or drops therebelow even when the number of rotations of the handle (handle speed) drops below the threshold value Vth (even when the completion of the handle operation is determined). For example, the handle operation determination unit 14 may set the dead time band for only a predetermined time which elapses after the number of rotations of the handle (handle speed) drops below the threshold value Vth.

In this way, even when chattering occurs in which the number of rotations of the handle (handle speed) is changed around the threshold value Vth for a short period of time, it is possible to reduce the unintended recording of a very large number of operation histories for a short period of time.

Although the embodiment of the present invention is described above, the present invention is not limited to the embodiment described above, and various modifications and variations are possible. For example, although in the embodiment described above, the machine tool having the history recording function is illustrated, the present disclosure is not limited thereto, and can be applied to various industrial machines having a history recording function.

### EXPLANATION OF REFERENCE NUMERALS

1 machine tool (industrial machine)
2 manual pulse generator (handle)
3 operation history storage device (external)
10 numerical controller
11 program operation unit
12 signal management unit (PLC)
13 drive axis control unit
14 handle operation determination unit
15 operation history recording unit
16 operation history storage unit

What is claimed is:

1. An industrial machine which has a history recording function, the industrial machine comprising:
a manual pulse generator which includes a handle for manually operating a position of a drive axis in the industrial machine by an operator;
a drive axis control unit which controls the drive axis according to the operation of the handle;
a handle operation determination unit which determines the operation of the handle; and
an operation history recording unit which records, as an operation history, the operation of the handle determined with the handle operation determination unit,
wherein when a number of rotations of the handle exceeds a threshold value, the handle operation determination unit determines the operation of the handle, and the operation history recording unit records, as the operation history, the operation of the handle.

2. The industrial machine according to claim 1, wherein the threshold value is set to the number of rotations of the handle, which is greater than 1, at which an event where the operation of the handle is a factor is estimated to occur.

3. The industrial machine according to claim 1, wherein when the number of rotations of the handle exceeds the threshold value, the handle operation determination unit determines start of the operation of the handle, and the operation history recording unit records, as the operation history, the start of the operation of the handle, and
wherein when the number of rotations of the handle drops below the threshold value, the handle operation determination unit determines completion of the operation of the handle, and the operation history recording unit records, as the operation history, the completion of the operation of the handle.

4. The industrial machine according to claim 1, wherein the handle operation determination unit has a plurality of the threshold values, and
wherein each time the number of rotations of the handle exceeds each of the threshold values, the handle operation determination unit determines the operation of the handle, and the operation history recording unit records, as the operation history, the operation of the handle.

5. The industrial machine according to claim 1, comprising: a plurality of the manual pulse generators for a plurality of the drive axes,
wherein the handle operation determination unit has a different threshold value for each of a plurality of the handles in the manual pulse generators.

6. The industrial machine according to claim 1, wherein the handle operation determination unit provides a dead rotations band which does not detect that the number of rotations of the handle exceeds the threshold value or drops therebelow even when the number of rotations of the handle exceeds the threshold value.

7. The industrial machine according to claim 1, wherein the handle operation determination unit provides a dead time band which does not detect that the number of rotations of the handle exceeds the threshold value or drops therebelow even when the number of rotations of the handle exceeds the threshold value.
